(19) United States
(12) Patent Application Publication
(10) Pub. No.: US 2025/0231898 A1
(43) Pub. Date: Jul. 17, 2025

(54) MULTI-MODE USB-C CONNECTION CABLE

(71) Applicant: Lerain Technology Co., Ltd., New Taipei City (TW)

(72) Inventors: MIAOBIN GAO, New Taipei City (TW); HENG-JU CHENG, New Taipei City (TW); HSIN-CHE CHIANG, New Taipei City (TW); HUI-CHIN WU, New Taipei City (TW); CHIA-CHI HU, New Taipei City (TW); YI CHUANG, New Taipei City (TW)

(21) Appl. No.: 18/769,663

(22) Filed: Jul. 11, 2024

(30) Foreign Application Priority Data
Jan. 17, 2024 (TW) 113101892

(51) Int. Cl. G06F 13/38; G06F 13/42; H01R 13/66

(52) U.S. Cl. CPC G06F 13/382; G06F 13/4282; H01R 13/6691

(57) ABSTRACT

A multi-mode USB-C connection cable is disclosed. The cable can connect between a first and a second electronic device and includes a first and a second connector port, a plurality of transmission wires, a first and a second auxiliary signal wire, and a first and a second adapter chip. The first and the second connector ports are connected to the first and the second electronic devices, and the plurality of transmission wires are connected between the first and the second the adapter chips. The first and the second auxiliary signal wires are used to receive a control signal from the first or the second device to adjust a first and a second voltage level. The first and the second adapter chips adjust a signal transmission mode of the plurality of transmission wires based on the first and the second voltage levels.

### BACKGROUND OF THE INVENTION

### 1. Field of the Invention

The present invention relates to a multi-mode USB-C connection cable, particularly to a multi-mode USB-C connection cable that can adjust an internal signal transmission direction according to different usage modes.

### 2. Description of the Related Art

With the advancement of technology, USB-C connection cables have become widely used. A USB-C connection cable is a type of Universal Serial Bus (USB) hardware interface format, characterized by its reversible connectors at both ends, eliminating the need to discern the correct orientation. Besides USB, the third generation of Thunderbolt ports can also utilizes USB-C connection cables. Additionally, multi-mode USB-C connection cables can support high-speed transmission for DisplayPort (DP), and there are also developments in DP-Asymmetric applications.

Please refer to FIG. 1, which illustrates a schematic diagram of the architecture of a multi-mode USB-C connection cable in the prior art.

In the prior art, the multi-mode USB-C connection cable 90 utilizes a first connector port 91, a second connector port 92, a transmission wire 94, and a CC (Configuration Channel) wire 96 to connect different electronic devices. The first connector port 91 and the second connector port 92 each have their first sides 911, 921 and second sides 912, 922, respectively. The first connector port 91 contains a first adapter chip 931 and a first microcontroller 951, and the second connector port 92 contains a second adapter chip 932 and a second microcontroller 952. The first adapter chip 931 and the second adapter chip 932 can adjust the transmission wire 94, for example, by changing its transmission direction or gain value. In the prior art, the multi-mode USB-C connection cable 90 determines the required signal transmission type using its internal CC wire 96. The CC wire 96 receives control signals from external electronic devices. However, the signals received by the CC wire 96 are encoded control signals, requiring decoding by the first microcontroller 951 or the second microcontroller 952 to adjust the first adapter chip 931 and the second adapter chip 932. This setup adds complexity and increases manufacturing costs.

Therefore, it is necessary to invent a new multi-mode USB-C connection cable to improve upon previous technology by simplifying the adjustment and configuration.

### SUMMARY OF THE INVENTION

The primary objective of present invention is to provide a multi-mode USB-C connection cable that can adjust the internal signal transmission direction and chip parameter settings according to different usage modes.

To achieve the above object, the multi-mode USB-C connection cable of the present invention is capable of connecting between a first electronic device and a second electronic device. The multi-mode USB-C connection cable includes a first connector port, a second connector port, a plurality of transmission wires, a first auxiliary signal wire, a second auxiliary signal wire, a first adapter chip, and a second adapter chip. The first connector port or the second connector port can be respectively connected to the first electronic device or the second electronic device. The plurality of transmission wires are connected between the first adapter chip and the second adapter chip, enabling signal transmission between the first electronic device and the second electronic device through the first and second connector ports and the plurality of transmission wires. The first auxiliary signal wire has a first voltage level, and the second auxiliary signal wire has a second voltage level. The first and second auxiliary signal wires are symmetrically arranged to connect between the first and second connector ports, receiving control signals from the first or second electronic device to change the voltage levels. The first adapter chip has a first set of adjustment parameters, and the second adapter chip has a second set of adjustment parameters. These chips are symmetrically placed within the first and second connector ports and adjust the parameters based on the voltage levels to modify the signal transmission mode of the plurality of transmission wires.

### BRIEF DESCRIPTION OF THE DRAWINGS

All of the objects and advantages of the present invention will become apparent from the following descriptions of the accompanying drawings, which disclose several embodiments of the present invention. It should be understood that the drawings are used for purposes of illustration only, and not as a definition of the invention.

FIG. 1 illustrates a schematic diagram of the architecture of a multi-mode USB-C connection cable in the prior art.

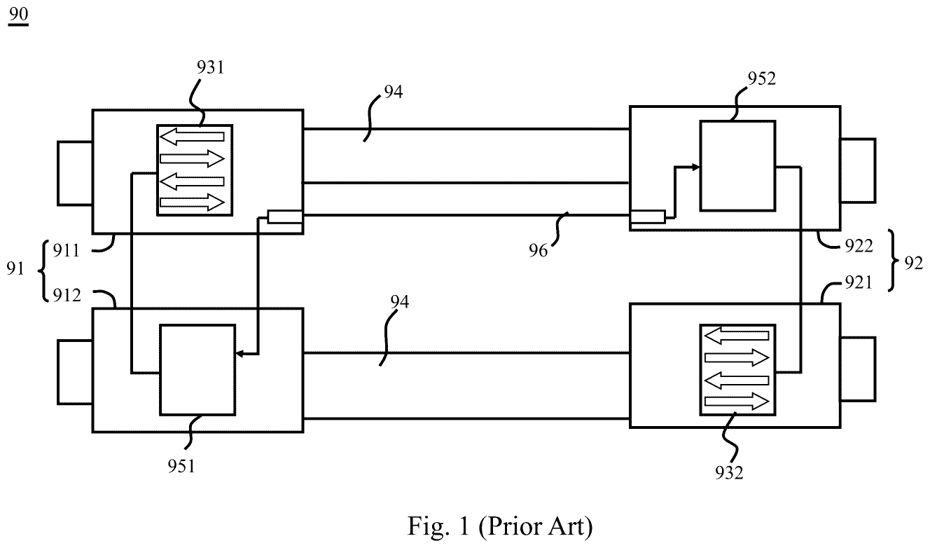

FIG. 2 illustrates a schematic diagram of the use of a multi-mode USB-C connection cable of the present invention connecting between a first electronic device and a second electronic device.

FIG. 3 illustrates a structural schematic of a first embodiment of the multi-mode USB-C connection cable of the present invention.

FIG. 4 illustrates a structural schematic of a second embodiment of the multi-mode USB-C connection cable of the present invention.

FIG. 5 illustrates a structural schematic of a third embodiment of the multi-mode USB-C connection cable of the present invention.

### DETAILED DESCRIPTION OF THE PREFERRED EMBODIMENTS

Preferred specific embodiments are presented below for better understanding of the technical contents of the present invention.

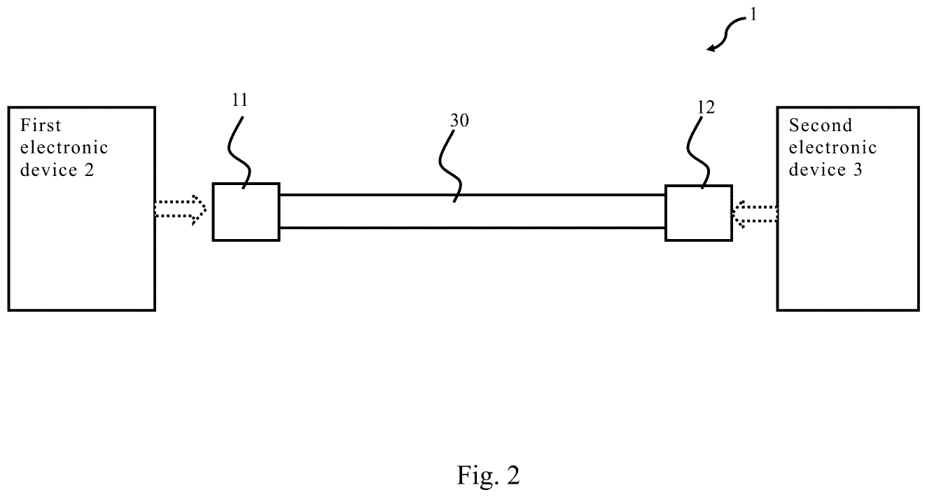

Please refer to FIG. 2, which illustrates a schematic diagram of the use of a multi-mode USB-C connection cable connecting between a first electronic device and a second electronic device of the present invention.

In one embodiment of the present invention, the multi-mode USB-C connection cable 1 is a hardware interface suitable for Universal Serial Bus (USB) or Thunderbolt specifications, although the present invention is not limited to these specifications. The multi-mode USB-C connection cable 1 utilizes the first connector port 11 and the second connector port 12 to connect between a first electronic device 2 and a second electronic device 3. The first electronic device 2 and the second electronic device 3 can be, but are not limited to, desktop computer systems, laptops, smartphones, tablets, wearable devices, or display screens. The first electronic device 2 can be configured as the host responsible for controlling and outputting signals, and the second electronic device 3 can be the device to be connected to and receive signals, although the invention is not limited to these roles. According to the specifications, the first connector port 11 and the second connector port 12 have identical top and bottom shapes, each with 24 pins (12 pins on each side), connecting to a plurality of transmission wires 30 inside the multi-mode USB-C connection cable 1. This allows the first connector port 11 and the second connector port 12 to be connected to the first electronic device 2 and the second electronic device 3 in either orientation, enabling forward or reverse signal transmission via the plurality of transmission wires 30. In this embodiment of the present invention, signal transmission from the first connector port 11 to the second connector port 12 is designated as forward transmission, and signal transmission from the second connector port 12 to the first connector port 11 is designated as reverse transmission; however, these terms are used for explanatory purposes and are not limiting. The connection method of the multi-mode USB-C connection cable 1 is well known to those skilled in the art to which the invention pertains and is therefore not further elaborated here.

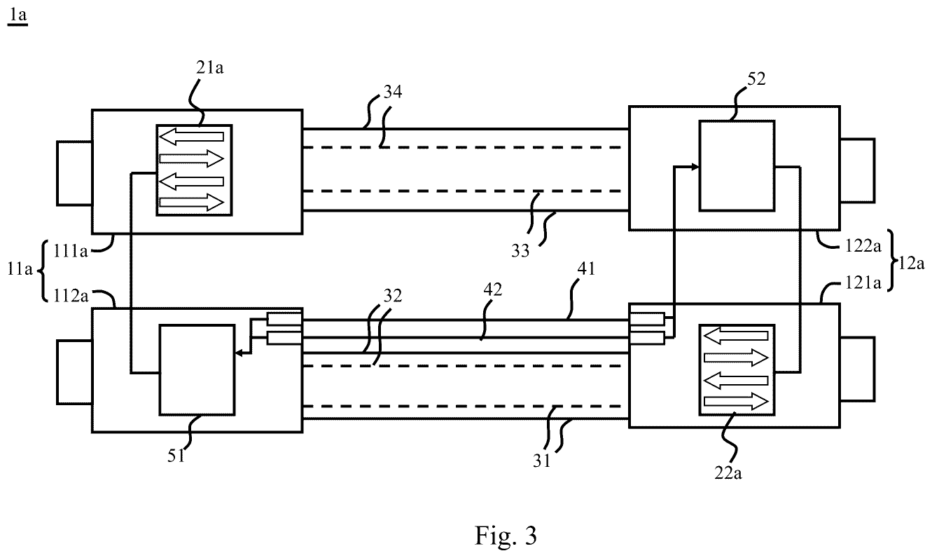

Please refer to FIG. 3, which illustrates a structural schematic of a first embodiment of the multi-mode USB-C connection cable of the present invention.

In the first embodiment of the present invention, the multi-mode USB-C connection cable 1a comprises a first connector port 11a, a second connector port 12a, a first adapter chip (Repeater) 21a, a second adapter chip 22a, a first set of transmission wires 31, a second set of transmission wires 32, a third set of transmission wires 33, a fourth set of transmission wires 34, a first auxiliary signal wire 41, a second auxiliary signal wire 42, a first microcontroller 51, and a second microcontroller 52. The first connector port 11a of multi-mode USB-C connection cable 1a has a first side 111a and a second side 112a, and the second connector port 12a has a first side 121a and a second side 122a. The first adapter chip 21a and the second adapter chip 22a are symmetrically positioned within the first connector port 11a and the second connector port 12a. In this first embodiment of the present invention, the first adapter chip 21a is positioned within the first connector port 11a on the first side 111a, and the second adapter chip 22a is positioned within the second connector port 12a on the first side 121a.

The plurality of transmission wires 30 include a first set of transmission wires 31, a second set of transmission wires 32, a third set of transmission wires 33, and a fourth set of transmission wires 34. The first connector port 11a and the second connector port 12a are electrically connected to the four sets of transmission wires 31, 32, 33, 34 via their respective internal pins. Each of the first adapter chip 21a and the second adapter chip 22a has four transmission channels. Therefore, the first electronic device 2 can be electrically connected to the first connector port 11a, and the second electronic device 3 can be electrically connected to the second connector port 12a, allowing signal transmission in both forward and reverse directions through transmission wires 31, 32, 33, 34. It is important to note that each set of transmission wires 31, 32, 33, 34 has positive and negative poles, represented in FIG. 3 by solid lines for positive channels and dashed lines for negative channels. Additionally, the internal circuit boards of the first connector port 11a and the second connector port 12a have at least one through-hole (not shown in the figure), allowing signals to pass through to the other side of the circuit board.

The first adapter chip 21a has a first set of adjustment parameters, and the second adapter chip 22a has a second set of adjustment parameters. These parameters can adjust the direction of signal transmission, meaning that they can set the first set of transmission wires 31, the second set of transmission wires 32, the third set of transmission wires 33, and the fourth set of transmission wires 34 to either forward or reverse transmission. Additionally, the first adapter chip 21a and the second adapter chip 22a can also adjust the gain or equalization values of the signal to compensate for signal attenuation or distortion during transmission. The functionality of the first adapter chip 21a and the second adapter chip 22a is not limited by the present invention.

The first auxiliary signal wire 41 and the second auxiliary signal wire 42 are symmetrically positioned to connect between the first connector port 11a and the second connector port 12a. The first auxiliary signal wire 41 has a first voltage level, and the second auxiliary signal wire 42 has a second voltage level. The first electronic device 2 or the second electronic device 3 can use control signals to change the first voltage level and the second voltage level. For example, the first voltage level can be changed to a high or low level, and similarly, the second voltage level can also be changed to a high or low level. This allows for four possible combinations: “high, high”, “high, low”, “low, high”, and “low, low”. It is important to note that the high or low levels mentioned above are just examples in this embodiment. Those skilled in the art to which this invention belongs will understand that the first voltage level and the second voltage level are not limited to measuring only high and low states.

In the first embodiment of the present invention, the multi-mode USB-C connection cable 1a also includes a first microcontroller 51 and a second microcontroller 52. The first microcontroller 51 and the second microcontroller 52 are symmetrically positioned within the first connector port 11a and the second connector port 12a, respectively. In FIG. 3, the first adapter chip 21a is positioned with the first microcontroller 51 on the first side 111a and the second side 112a of the first connector port 11a, while the second adapter chip 22a is positioned with the second microcontroller 52 on the first side 121a and the second side 122a of the second connector port 12a. However, the present invention is not limited to this configuration. The first microcontroller 51 and the second microcontroller 52 can have multi-level voltage quantizers (such as ADC) or single-level voltage quantizers (such as comparators) connected electrically to the first auxiliary signal wire 41 and the second auxiliary signal wire 42 via GPIO (general-purpose input/output) to measure the first voltage level and the second voltage level. The first adapter chip 21a and the second adapter chip 22a then adjust the signal transmission mode of the transmission wires 31, 32, 33, 34 based on the measured first voltage level and second voltage level.

Therefore, in the first embodiment of the present invention, the multi-mode USB-C connection cable 1a can have at least multiple transmission modes based on the specifications or settings of the first electronic device 2 or the second electronic device 3, including Universal Serial Bus (USB) mode, Thunderbolt (TBT) mode, and other possible transmission modes. The first electronic device 2 or the second electronic device 3 can control the high and low levels of the first voltage level and the second voltage level according to different modes. For example, in USB mode, the first voltage level and the second voltage level are “high, high,” while in TBT mode, they are “high, low.” Similarly, the first voltage level and the second voltage level can also be “low, high” or “low, low” to represent other possible modes. The high and low levels of the above modes are just examples in this embodiment, and the present invention is not limited to this configuration. The first adapter chip 21a and the second adapter chip 22a can adjust the first set of adjustment parameters and the second set of adjustment parameters based on the high and low levels of the first voltage level and the second voltage level such that the transmission wires 31, 32, 33, 34 are adjusted to the appropriate signal transmission mode.

For example, in USB mode, the first adapter chip 21a and the second adapter chip 22a set the second set of transmission wires 32 and the fourth set of transmission wires 34 to forward transmission and the first set of transmission wires 31 and the third set of transmission wires 33 to reverse transmission. In TBT mode, the first adapter chip 21a and the second adapter chip 22a set the second set of transmission wires 32 and the fourth set of transmission wires 34 to forward transmission and the first set of transmission wires 31 and the third set of transmission wires 33 to reverse transmission. Furthermore, the first adapter chip 21a and the second adapter chip 22a adjust the signal transmission power and speed to meet the requirements of the TBT mode. In other modes, the first set of transmission wires 31 to the fourth set of transmission wires 34 can be set for forward or reverse transmission as needed. Additionally, the first adapter chip 21a and the second adapter chip 22a can be further configured to adjust other parameters to meet the signal transmission power and speed requirements of other modes. For instance, all transmission wires 31 to 34 can be set to forward transmission or specific sets can be configured to forward and others to reverse transmission, etc. The present invention is not limited to these examples.

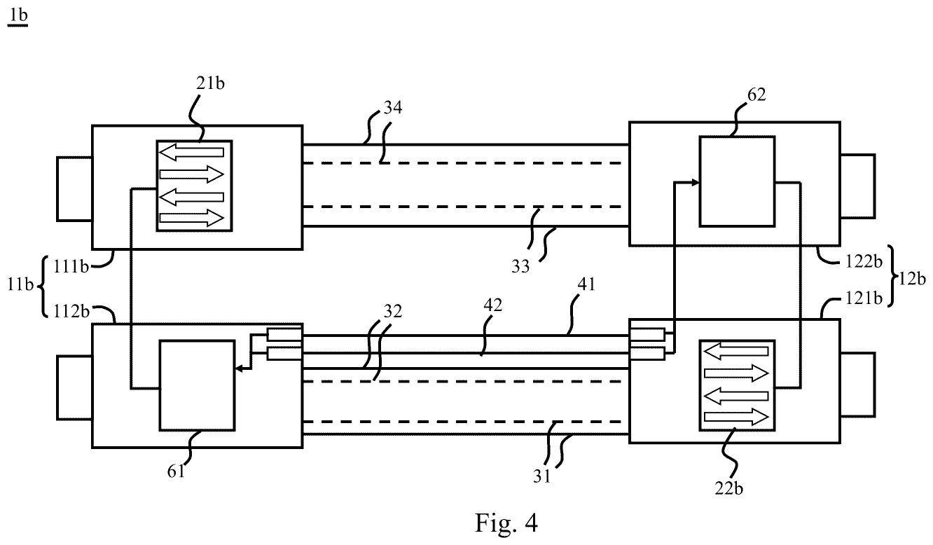

Now please refer to FIG. 4, which illustrates a structural schematic of a second embodiment of the multi-mode USB-C connection cable of the present invention.

In the second embodiment of the present invention, the multi-mode USB-C connection cable 1b includes a first connector port 11b, a second connector port 12b, a first adapter chip 21b, a second adapter chip 22b, a first set of transmission wires 31, a second set of transmission wires 32, a third set of transmission wires 33, a fourth set of transmission wires 34, a first auxiliary signal wire 41, a second auxiliary signal wire 42, a first voltage detector 61, and a second voltage detector 62. The first connector port 11b of the multi-mode USB-C connection cable 1b has a first side 111b and a second side 112b, and the second connector port 12b has a first side 121b and a second side 122b. The first adapter chip 21b and the second adapter chip 22b are symmetrically arranged within the first connector port 11b and the second connector port 12b, specifically within the first side 111b and first side 121b, respectively. The first connector port 11b and the second connector port 12b are electrically connected to the first set of transmission wires 31, the second set of transmission wires 32, the third set of transmission wires 33, and the fourth set of transmission wires 34 via their respective internal pins. The first auxiliary signal wire 41 and the second auxiliary signal wire 42 are symmetrically arranged to connect between the first connector port 11b and the second connector port 12b, with the first auxiliary signal wire 41 having a first voltage level and the second auxiliary signal wire 42 having a second voltage level. Unlike the first embodiment, the second embodiment includes the first voltage detector 61 and the second voltage detector 62, which are symmetrically arranged within the first connector port 11b and the second connector port 12b, respectively. In FIG. 4, the first adapter chip 21b is positioned with the first voltage detector 61 within the first connector port 11b on the first side 111b and second side 112b, while the second adapter chip 22b is positioned with the second voltage detector 62 within the second connector port 12b on the first side 121b and second side 122b. However, the present invention is not limited to this configuration. The first voltage detector 61 and the second voltage detector 62 can utilize multi-level voltage quantizers or single-level voltage quantizers to directly electrically connect to the first auxiliary signal wire 41 and the second auxiliary signal wire 42 to measure the first voltage level and the second voltage level. The first adapter chip 21a and the second adapter chip 22a then determine how to adjust the signal transmission mode of the transmission wires 31, 32, 33, and 34 based on the measured first voltage level and second voltage level.

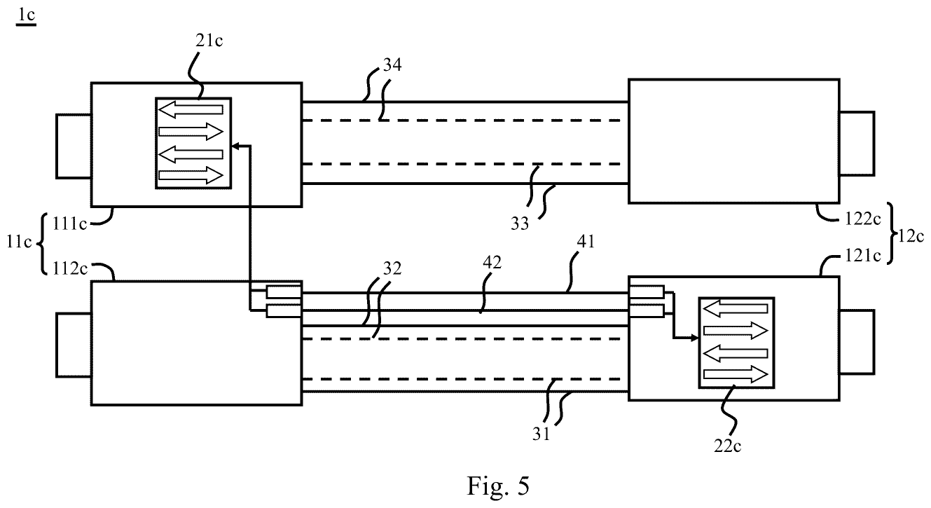

Finally, please refer to FIG. 5, which illustrates a structural schematic of a third embodiment of the multi-mode USB-C connection cable of the present invention.

In the third embodiment of the present invention, the multi-mode USB-C connection cable 1c comprises a first connector port 11c, a second connector port 12c, a first adapter chip 21c, a second adapter chip 22c, a first set of transmission wires 31, a second set of transmission wires 32, a third set of transmission wires 33, a fourth set of transmission wires 34, a first auxiliary signal wire 41, and a second auxiliary signal wire 42. The first connector port 11c of the multi-mode USB-C connection cable 1c has a first side 111c and a second side 112c, and the second connector port 12c has a first side 121c and a second side 122c. The first adapter chip 21c and the second adapter chip 22c are symmetrically positioned within the first connector port 11c and the second connector port 12c, respectively, on their respective first sides 111c and 121c. The first connector port 11c and the second connector port 12c are electrically connected to the first set of transmission wires 31, the second set of transmission wires 32, the third set of transmission wires 33, and the fourth set of transmission wires 34 through their respective internal pins. The first auxiliary signal wire 41 and the second auxiliary signal wire 42 are symmetrically positioned to connect between the first connector port 11c and the second connector port 12c, with the first auxiliary signal wire 41 having a first voltage level and the second auxiliary signal wire 42 having a second voltage level. Unlike the first and second embodiments, the third embodiment only includes the first adapter chip 21c and the second adapter chip 22c. The first adapter chip 21c and the second adapter chip 22c can directly electrically connect to the first auxiliary signal wire 41 and the second auxiliary signal wire 42 using their multi-layer voltage quantizers or single-layer voltage quantizers to measure the first voltage level and the second voltage level, thereby determining how to adjust the signal transmission mode of the transmission wires 31, 32, 33, 34.

The multi-mode USB-C connection cables 1, 1a, 1b, 1c of the present invention utilize the voltage levels of the internal first auxiliary signal wire 41 and second auxiliary signal wire 42 as a convenient basis for mode determination. This approach is much simpler than the previous technique of using a single CC wire 96 for determination, resulting in cost reduction in manufacturing.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A multi-mode USB-C connection cable for connecting between a first electronic device and a second electronic device, comprising:
a first connector port;
a second connector port, where the first connector port or the second connector port can be respectively connected to the first electronic device or the second electronic device;
a plurality of transmission wires connecting a first adapter chip and a second adapter chip, allowing the transmission of a signal between the first electronic device and the second electronic device via the first connector port, the second connector port, and the plurality of transmission wires;
a first auxiliary signal wire with a first voltage level;
a second auxiliary signal wire with a second voltage level, wherein the first auxiliary signal wire and the second auxiliary signal wire are symmetrically configured to connect between the first connector port and the second connector port, used for receiving a control signal from the first electronic device or the second electronic device to adjust the first voltage level and the second voltage level;
a first adapter chip with a first set of adjustment parameters; and
a second adapter chip with a second set of adjustment parameters, wherein the first adapter chip and the second adapter chip are symmetrically configured in the first connector port and the second connector port to adjust the first set of adjustment parameters and the second set of adjustment parameters based on the first voltage level and the second voltage level so as to adjust a signal transmission mode of the plurality of transmission wires.

2. The multi-mode USB-C connection cable as claimed in claim 1, further comprising:
a first microcontroller; and
a second microcontroller, wherein the first microcontroller and the second microcontroller detect the first voltage level of the first auxiliary signal wire and the second voltage level of the second auxiliary signal wire so as to enable the first adapter chip and the second adapter chip to determine the first voltage level and the second voltage level.

3. The multi-mode USB-C connection cable as claimed in claim 1, further comprising:
a first voltage detector; and
a second voltage detector, wherein the first voltage detector and the second voltage detector detect the first voltage level of the first auxiliary signal wire and the second voltage level of the second auxiliary signal wire, so as to enable the first adapter chip and the second adapter chip to determine the first voltage level and the second voltage level.

4. The multi-mode USB-C connection cable as claimed in claim 1, wherein the first adapter chip and the second adapter chip directly detect the first voltage level of the first auxiliary signal wire and the second voltage level of the second auxiliary signal wire.

5. The multi-mode USB-C connection cable as claimed in claim 1, wherein the plurality of transmission wires comprise a first set of transmission wires, a second set of transmission wires, a third set of transmission wires, and a fourth set of transmission wires.

6. The multi-mode USB-C connection cable as claimed in claim 5, wherein the first set of adjustment parameters and the second set of adjustment parameters are used to adjust a signal transmission direction and a signal transmission specification of the plurality of transmission wires.

7. The multi-mode USB-C connection cable as claimed in claim 6, wherein the first set of adjustment parameters and the second set of adjustment parameters are used to adjust the second set of transmission wires and the fourth set of transmission wires for forward transmission, and the first set of transmission wires and the third set of transmission wires for reverse transmission.

8. The multi-mode USB-C connection cable as claimed in claim 6, wherein the first set of adjustment parameters and the second set of adjustment parameters are used to adjust the first set of transmission wires, the second set of transmission wires, the third set of transmission wires, and the fourth set of transmission wires, all for forward transmission.

9. The multi-mode USB-C connection cable as claimed in claim 6, wherein the first set of adjustment parameters and the second set of adjustment parameters are used to adjust the first set of transmission wires, the second set of transmission wires, and the third set of transmission wires for forward transmission, and the fourth set of transmission wires for reverse transmission.
